(19) United States
(12) Patent Application Publication
(10) Pub. No.: US 2017/0233569 A1
(43) Pub. Date: Aug. 17, 2017

(54) ELECTRICALLY CONDUCTIVE SHEET MOLDING COMPOUND

(71) Applicant: OCV Intellectual Capital, LLC, Toledo, OH (US)

(72) Inventor: Mitsuru Akagawa, Ibaraki (JP)

(73) Assignee: OCV Intellectual Capital, LLC, Toleda, OH (US)

(21) Appl. No.: 15/503,030

(22) PCT Filed: Aug. 12, 2015
(86) PCT No.: PCT/US2015/044761

§ 371 Date: Feb. 10, 2017

Related U.S. Application Data
(60) Provisional application No. 62/036,245, filed on Aug. 12, 2014.

(51) Int. Cl. C08L 67/06; H01B 1/20; B01J 13/16

(52) U.S. Cl. CPC C08L 67/06; B01J 13/16; H01B 1/20; C08L 2205/14

(57) ABSTRACT

An electrically conductive fiber reinforced thermosetting resin molding compound which includes a microencapsulated curing agent is provided. Any electrically conductive fillers, including carbon fillers and metal fillers, may be used to impart electrical conductivity to the fiber reinforced thermosetting resin molding compound.

### RELATED APPLICATIONS

This application claims priority to and all benefit of U.S. Provisional Patent Application Ser. No. 62/036,245, filed on Aug. 12, 2014, for ELECTRICALLY CONDUCTIVE SHEET MOLDING COMPOUND, the entire disclosure of each of which is fully incorporated herein by reference.

### BACKGROUND

Sheet molding compounds (“SMC”), bulk molding compounds (“BMC”), and thick molding compounds (“TMC”) are fiber reinforced thermosetting resin molding compositions (sometimes referred to hereinafter alone and/or together as “compounds” in accordance with customary practice in this field) which are widely used in industrial molding processes such as compression molding. Such fiber reinforced thermosetting resin molding compounds typically comprise a curable polymer resin and a curing agent capable of causing the resin to rapidly cure when the molding compound is heated or otherwise processed to activate the curing agent.

In order to increase productivity, such fiber reinforced thermosetting resin molding compounds are often made with high activity curing agents. Unfortunately, this often leads to a corresponding decrease in shelf life relative to conventional fiber reinforced thermosetting resin molding compounds, which typically have a shelf-life on the order of three months.

In certain applications, it may be desirable to impart electrical conductivity to such fiber reinforced thermosetting resin molding compounds. To impart electrical conductivity to other materials such as plastics, an electrically conductive substance such as carbon filler or metal filler is added to the plastic. However, in standard fiber reinforced thermosetting resin molding compositions, the electrically conductive fillers rapidly react with the resin curing agents, particularly the high activity curing agents. Thus, in conventional processes the desired electrically conductive fillers cannot be added to fiber reinforced thermosetting resin molding compounds in a sufficient concentration to impart electrical conductivity without decreasing shelf-life.

To address the issue of decreased shelf-life in fiber reinforced thermosetting resin molding compounds, it has already been proposed to microencapsulate the curing agent in a suitable protective coating or shell. For example, WO 84/01919, the entire disclosure of which is incorporated herein by reference, describes a process for making microencapsulated curing agents for unsaturated polyester resin SMCs and BMCs in which an organic peroxide curing agent is microencapsulated in a phenol-formaldehyde resin shell. An alternative approach is described in JP 4175321, the entire disclosure of which is also incorporated herein by reference. In this approach, the organic peroxide curing agent is microencapsulated in gelatin or the like.

### SUMMARY

In accordance with this disclosure, it has been found that electrically conductive substances such as carbon fillers and metal fillers can be added to fiber reinforced thermosetting resin molding compounds in a sufficiently high concentration to impart electrical conductivity by microencapsulating the curing agent in a coating or shell made from a polyurethane resin.

Thus, the general inventive concept disclosed herein provides an electrically conductive fiber reinforced thermosetting resin molding compound which includes a microencapsulated curing agent for use in curing a thermosetting resin.

In addition, this disclosure also provides a molding compound comprising a carbon filler together with a thermosetting resin and a microencapsulated curing agent, the microencapsulated curing agent comprising an organic peroxide curing agent and a shell formed from a polyurethane resin encapsulating the organic peroxide curing agent.

### DETAILED DESCRIPTION

### Thermosetting Resin Composition

The general inventive concepts contemplate an electrically conductive fiber reinforced thermosetting resin molding compound made using any type of thermosetting resin composition. Specific examples of thermosetting resins that can be used to make the thermosetting resin compositions include unsaturated polyester resins, vinyl ester resins and epoxy resins. In some exemplary embodiments, unsaturated polyester resins and especially unsaturated polyester resin compositions containing styrene, vinyl toluene and other vinyl polymerizable monomers, especially vinyl polymerizable aromatic monomers, as cross-linking agents may be used.

Thermosetting resin compositions used for molding operations often combine with reinforcing fibers to make a fiber reinforced thermosetting resin molding compound, and such reinforcing fibers can be included in the electrically conductive thermosetting resin molding compound if desired. Examples include glass fibers, carbon fibers, etc. In some exemplary embodiments, glass fibers having a filament diameter of about 5 to about 20 μm may be used. In some exemplary embodiments, glass fibers having a filament diameter of about 15.6 μm are used. Such glass fibers can be continuous or chopped, and, if chopped, desirably have a length of about 10 to about 100 mm. In some exemplary embodiments, the chopped glass fibers have a length of about 25.4 mm. In addition, such filaments can also be formed into strands. Strands having a yarn count (weight per unit length) of about 500 to about 5,000 gm/km may be particularly useful, as may those having a bundling number of about 50 to about 200 filaments per strand. In some exemplary embodiments, bundling may include about 150 filaments per strand. If desired, such glass fibers, and/or the strands and yarns made therefrom can be coated with a suitable sizing agent containing a silane coupling agent, optionally a film forming agent such as a polyurethane or polyvinyl acetate resin, and optionally other conventional ingredients such as cationic and nonionic surfactants and the like. In some exemplary embodiments, sizing amounts of about 0.2 to about 2 wt. %, based on the weight of the glass fiber being coated, are added to the glass fibers. In certain exemplary embodiments, about 1 wt. % of sizing may be added to the glass fibers.

Any amount of reinforcing fibers can be included in the inventive thermosetting resin molding compounds. Reinforcing fiber concentrations on the order of about 10 to about 60 wt. %, about 20 to about 50 wt. %, or about 30 wt % based on the weight of the thermosetting composition as a whole, are encompassed by the general inventive concept.

The thermosetting resin compositions can also contain a wide variety of additional ingredients including conventional fillers such as calcium carbonate, aluminum hydroxide, clays, talcs and the like; thickeners such as magnesium oxide and magnesium hydroxides and the like; low shrinkage additives such as polystyrene, etc.; mold release agents such as zinc stearate, etc.; ultraviolet light absorbers; flame retardants; anti-oxidants; and the like. See, for example, pages 1-3, 6 and 7 of the above-noted WO 84/01919.

### Electrically Conductive Fillers

In various exemplary embodiments of this invention, a conductive filler is used to make an electrically conductive fiber reinforced thermosetting resin molding compound. In some exemplary embodiments, the conductive filler includes a metal filler such as, for example, aluminum, steel, copper, zinc, silver, palladium, nickel, and stainless steel. In some exemplary embodiments, the conductive filler includes one or more of zinc oxide or tin oxide. In some exemplary embodiments, the conductive filler may be an organic filler such as carbon black. In some exemplary embodiments, the conductive filler may comprise other materials including, but not limited to, carbon fiber, metal coated glass fiber, and metal coated glass balloon.

In some exemplary embodiments, the conductive filler is added to the fiber reinforced thermosetting resin molding compound to faun a pre-mix. In some exemplary embodiments, the conductive filler is added in an amount from about 1 to about 30 wt. %, about 3 to about 20 wt. %, or about 5 wt. % by weight of the fiber reinforced thermosetting resin molding compound. In some exemplary embodiments, the conductive filler is added in an amount from about 5 to about 40 wt. %, about 10 to about 30 wt. %, or about 15 wt. % by weight of the thermosetting resin.

In some exemplary embodiments, a carbon black filler is added to the fiber reinforced thermosetting resin molding compound to impart electrical conductivity. Carbon black provides good dispersion and stability within the fiber reinforced thermosetting resin molding compound.

### Curing Agents

As appreciated by those skilled in the art, heat activated curing agents for thermosetting resins desirably remain essentially unreactive until they reach their predetermined activation temperatures, at which time they rapidly react (decompose) to yield free radicals for curing.

One analytical test for measuring the ability of a curing agent to remain essentially unreactive at lower temperatures is the active oxygen residual ratio at 40° C. test. In accordance with this test, a quantity of the curing agent is maintained at 40° C. for 48 hours and then the amount of active oxygen (i.e., the proportion of curing agent that remains active to produce free radicals) is determined by heating the curing agent to its activating temperature. In some exemplary embodiments, the microencapsulated curing agents of this invention desirably exhibit an active oxygen residual ratio at 40° C. of at least 80%, more desirably at least 95%.

An analytical test for measuring the ability of a curing agent to rapidly react at its activation temperature is the one minute half life temperature test. In accordance with this test, a quantity of the curing agent is heated for one minute at an elevated temperature and the proportion of the curing agent that remains active to produce free radicals is then determined. The test is repeated at a variety of different temperatures to determine the temperature at which half the curing agent remains active, which is taken as the one minute half life temperature of the curing agent.

In some exemplary embodiments, the microencapsulated curing agents desirably exhibit a one minute half life temperature of about 115° C. to about 140° C., more desirably about 120° C. to about 130° C.

Exemplary curing agents which have been found to exhibit an active oxygen residual ratio when heated for 48 hours at 40° C. of at least 80% and a one minute half life temperature of about 115° C. to 140° C. include dilauroyl peroxide, t-butyl peroxy-2-ethylhexanoate, 1,1,3,3-tetramethyl buytlperoxy-2-ethylhexanoate, t-amyl-2-peroxhy-2-ethylhexanoate, and dibenzoyl peroxide. In some exemplary embodiments, the curing agent includes one or both of t-amyl-2-peroxy-2-ethylhexanoate and dibenzoyl peroxide.

The exemplary curing agents described above may be microencapsulated in a polyurethane resin protective coating by means of interfacial polymerization. Interfacial polymerization is a process wherein a microcapsule wall of a polymer resin such as a polyamide, an epoxy resin, a polyurethane resin, a polyurea resin, or the like is formed at an interface between two phases. The interfacial polymerization process includes (a) dissolving the peroxide curing agent and the isocyanate forming the polyurethane in an organic solvent, which is essentially immiscible with water, and a non-solvent for the polyol and optional polyamine forming the polyurethane, (b) emulsifying the organic solution so formed in an aqueous phase by vigorous mixing, and (c) adding the polyol and optional polyamine to the emulsion so formed with continuous mixing to cause the polyurethane to form at the interface of the emulsified particles.

Forming microcapsules by interfacial polymerization is well-known and described in a number of publications. For example, such techniques are described in Masumi, et al., CREATION AND USE OF MICROCAPSULES, “1-3 Manufacturing Method and Use of Microcapsules,” Pages 12-15, ©2005 by Kogyo Chosa Kai K. K. (ISBN4-7693-4194-6 C3058). Such techniques are also described in Mitsuyuki et al., APPLICATION AND DEVELOPMENT OF MICRO/NANO SYSTEM CAPSULE AND FINE PARTICLES, “4-3 Manufacturing Method of Thermal Responsive Microcapsules,” Pages 95-96, ©2003 by K.K. CMC Shuppan (ISBN978-4-7813-0047-4 C3043).

U.S. Pat. No. 4,622,267 also discloses an interfacial polymerization technique for preparation of microcapsules. The core material is initially dissolved in a solvent. An aliphatic diisocyanate soluble in the solvent mixture is added. Subsequently, a nonsolvent for the aliphatic diisocyanate is added until the turbidity point is just barely reached. This organic phase is then emulsified in an aqueous solution, and a reactive amine is added to the aqueous phase. The amine diffuses to the interface, where it reacts with the diisocyanate to form polymeric polyurethane shells. A similar technique used to encapsulate salts, which are sparingly soluble in water, in polyurethane shells is disclosed in U.S. Pat. No. 4,547,429.

Any suitable technique, including the aforementioned conventional technique, can be used for making the microencapsulated curing agents of this invention. Normally, these techniques will be carried out so that the amount of organic peroxide curing agent forming the core of the microencapsulated curing agent constitutes at least about 15 wt. %, more typically at least about 20 wt. %, at least about 25 wt. %, at least about 30 wt. %, at least about 35 wt. %, or even at least about 40 wt. %, of the microencapsulated curing agent as a whole. The amount of organic peroxide curing may be about 15 to about 70 wt. %, about 30 to about 70 wt. % or even about 40 to about 70 wt. %, based on the weight of the product microencapsulated curing agent as a whole.

### Product Microcapsules

The interfacial polymerization process contemplated by the general inventive concepts is preferably carried out to produce product microcapsules having a desired combination of particle size, activity, heat stability and chemical stability.

### Particle Size and Form

Regarding particle size, for achieving a uniform distribution of the microencapsulated curing agent in the thermosetting resin composition as well as sufficient activity in terms of evolving the desired amount of organic peroxide, the microcapsules desirably have an average particle size of about 5 μm to about 500 μm, preferably about 30 μm to about 300 μm, more preferably about 50 μm to about 150 μm.

Also, when combined with a thermosetting resin and other ingredients for making a particular thermosetting resin composition in accordance with this disclosure, the microcapsules are desirably in the faun of a dried powder or a liquid slurry. Dried powders are preferred, as they promote good dispersibility in the resin compositions in which they are contained. Dried powders can also avoid the ill effects of added moisture.

### Thermal Characteristics—Activity

To insure that the microcapsules rapidly decompose to liberate sufficient organic peroxide at their predetermined activation temperatures, the microcapsules desirably exhibit a decrease in the net amount of organic peroxide contained therein of at least about 4 wt. %, preferably at least about 18 wt. %, more preferably at least about 22 wt. %, or even at least about 25 wt. %, when heated to 140° C. for 5 minutes. This can easily be determined by comparing the decrease in gross weight of the microcapsule in response to this heating regimen with the total weight of the organic peroxide in the original microcapsule, since essentially all of the decrease in weight experienced by the microcapsule when heated will be due to decomposition of its organic peroxide. The rapid decomposition and liberation of organic peroxide specified in this thermal activity test is especially desirable for microcapsules used in fiber reinforced thermosetting resin molding compounds, such as SMC, where curing needs to be very rapid once the predetermined curing temperature is reached.

### Thermal Characteristics—Long Term Stability

To prevent premature aging or thickening of the electrically conductive fiber reinforced thermosetting resin molding compounds (e.g., SMC) containing the microcapsules, these microcapsules should exhibit a decrease in the net amount of organic peroxide contained therein of no more than about 10 wt. %, preferably no more than about 8 wt. %, more preferably no more than about 7 wt. %, even more preferably no more than about 5 wt. %, no more than about 3 wt. %, or even no more than about 2 wt. %, when heated to 100° C. for 30 minutes. This is desirable for ensuring that the electrically conductive fiber reinforced thermosetting resin molding compounds containing the microcapsules exhibit a sufficient shelf life.

### Thermal Characteristics—Short Term Stability

To achieve good surface appearance in molded articles made with electrically conductive fiber reinforced thermosetting resin molding compounds (e.g., SMC) containing the microcapsules, the microcapsules also desirably exhibit a decrease in the net amount of organic peroxide contained therein of no more than about 5 wt. %, preferably no more than about 4 wt. %, more preferably no more than about 2 wt. %, or even no more than about 1 wt. %, when heated to 140° C. for 30 seconds. When a molding compound is compression molded, there is normally a slight delay between the time the molding compound is charged into the heated metal mold and the molding compound is pressurized inside the mold for completing the molding operation. Poor surface appearance (e.g., inadequate smoothness) is often caused by different portions of the molding compound being exposed to different curing conditions inside the mold. For example, the curing conditions experienced by portions of the molding compound directly touching the heated metal surfaces of the mold are normally more severe, at least slightly, than the curing conditions experienced by other portions of the molding compound. To achieve good surface appearance (e.g., adequate smoothness) in the molded articles, it is therefore desirable that curing does not substantially begin until the increase in molding pressure is achieved, so that this difference in curing conditions does not occur, or is otherwise minimized. Therefore, it is also desirable that microcapsules exhibit the short term thermal stability described herein, as this ensures that premature curing of the thermosetting resin is avoided or otherwise reduced.

### Chemical Stability

To avoid possible deleterious effects due to leakage of the organic peroxide, the microcapsules should exhibit a decrease in the net amount of organic peroxide contained therein of no more than 15 wt. %, preferably no more than about 10 wt. %, more preferably no more than about 5 wt. %, when soaked in styrene monomer for 48 hours at 23° C. Microcapsules exhibiting no leakage of the organic peroxide when subjected to these conditions are even more desirable. This resistance against degradation in styrene monomer is desirable for insuring that electrically conductive fiber reinforced thermosetting resin molding compounds containing the microcapsules exhibit a sufficient shelf life.

### Raw Materials

As raw materials of the polyurethane resin, an isocyanate and a polyol can be mainly used. For example, xylylene diisocyanate (XDI), hydrogenated xylylene diisocyanate (H₆XDI), hexamethylene diisocyanate (HDI), isophorone diisocyanate (IPDI), tolylene diisocyanate (TDI), diphenylmethane diisocyanate (MDI), or a polyisocyanate comprising one or more of these isocyanates can be used as the isocyanate. As for the polyol, any polyol which is at least partially soluble in water can be used. Examples include glycerin, polyethylene glycol, and butanediol. Water may also be used. Polyethylene glycols are preferred, especially those having molecular weights of about 200 to about 20,000, more typically about 200 to about 10,000 or even about 200 to about 5,000.

The activity, heat stability, and chemical stability of the curing agent microcapsules depend, among other things, on the raw materials and the wall thickness of the polyurethane resin protective coating which microencapsulates the organic peroxide curing agent. To this end, especially for chemical stability, the isocyanate used to make the polyurethane resin coating of the microcapsules may be selected from one or more of xylylene diisocyanate, hydrogenated xylylene diisocyanate, hexamethylene diisocyanate, isophorone diisocyanate, and polyisocyanates obtained from these diisocyanates, while the polyol used to make this polyurethane resin is preferably polyethylene glycol. Water may also be used.

In addition to the isocyanate and polyol, a polyamine can also be included in the reaction system for making the polyurethane shell of the microcapsules. Polyamines react more quickly with polyisocyanates, and therefore can be used to help control the rate at which the interfacial polymerization reaction occurs. In addition, polyamines with functionalities greater than two can introduce chain branching (crosslinking) into the polyurethane and hence help control the properties of the polyurethane shell. Any polyamine which is at least partially soluble in water can be used for this purpose. In some exemplary embodiments, diamines and especially hexamethylene diamine are included in the reaction system.

While any amount of this optional polyamine can be used, typically the amount will be >0 wt. % to about 50 wt. %, more typically, about 20 wt. % to about 48 wt. % or even about 25 wt. % to about 45 wt. % of the combined amounts of polyol and polyamine.

As noted in the above publications discussing interfacial polymerization, it may also be desirable to include a colloid-forming agent in the aqueous phase of such reaction systems, as such materials control interfacial tension thereby stabilizing the shape of the emulsified particles. In addition, such materials also form a layer of protective colloid on the surfaces of these particles. Any suitable colloid-forming materials, including conventional colloid-forming materials, which are known to be useful as a colloid-forming agent in interfacial polymerization can be used. In some exemplary embodiments, polyvinyl alcohol, hydroxymethyl cellulose, and similar thickening agents are used

### Wall Thickness

In some exemplary embodiments, the coating or shell made from the polyurethane resin has a wall thickness on the order of about 0.2 μm to about 80 μm, including about 0.5 μm to about 50 μm or about 1 μm to about 10 μm. These raw materials and wall thickness are desirable for achieving the desired combination of heat stability, chemical stability, and activity described herein. Wall thicknesses which are too thin may lead to premature leaking of the curing agent, which in turn may lead to inadequate shelf life. Conversely, wall thicknesses which are too large may lead to inadequate activity, which in turn may lead to insufficient curing and/or poor surface appearance. In general, the particular wall thickness needed to achieve a desired combination of heat stability, chemical stability, and activity depends on many factors including the particular curing agent used and the particular operating characteristics desired in the product. This can readily be determined by routine experimentation.

### Loadings

The amount of microcapsules that can be included in thermosetting resin compositions made in accordance with this disclosure can vary widely, and essentially any suitable amount can be used. In general, the amount of microcapsules included in a particular thermosetting resin composition should be sufficient so that the net amount of organic peroxide present is about 0.2 PHR (parts per hundred parts resin by weight) to about 6 PHR, more typically about 0.8 PHR to about 5 PHR, or about 1 PHR to about 4 PHR.

### EXAMPLES

The following examples are provided to more thoroughly describe and illustrate the inventive concepts. These examples are not intended to limit the invention as described and suggested herein, and as presented in the appended claims.

A microencapsulated curing agent was prepared by microencapsulating 34.5 wt. % of an organic peroxide comprising t-amyl peroxy 2-ethylhexanoate in a polyurethane shell by interfacial polymerization. A core material was prepared by mixing, agitating, and dissolving 100 parts by weight of TRIGONOX 121 (curing agent available from Kayaku Akzo Corporation containing 94 wt. % oft-amyl peroxy 2-ethylhexanoate) and 40 parts by weight of XDI polyisocyanate in 100 parts by weight of tricresyl phosphate (TCP). The core material was poured into 500 parts by weight of an aqueous solution of polyvinyl alcohol (PVA), and the mixture so obtained was agitated at high speed to emulsify the core material in the aqueous phase. Mixing was continued until the average diameter of emulsified droplets decreased to about 100 μm, (approximately 1.5 hours). Then, 4 parts by weight of polyethylene glycol and 3 parts by weight of hexamethylenediamine were added, and the mixture so formed allowed to react for 3 hours at 50° C. As a result, a slurry of microcapsules having an average diameter of 100 μm, a core composed of TRIGONOX 121 and TCP, and a shell formed from a polyurethane resin was obtained. These microcapsules were then removed from the slurry and vacuum dried to produce the microencapsulated curing agents in accordance with this disclosure.

An exemplary electrically conductive sheet molding compound (hereinafter, “Conductive SMC”) was prepared in accordance with the general inventive concepts. In the following examples, a precursor electrically conductive molding resin pre-mix was prepared by TOKYO PRINTING-INK MFG. by combining electrically conductive carbon black with unsaturated polyester resin. An optional viscosity reduction agent or filler dispersing agent may be used in preparing the exemplary pre-mix, if needed to adjust the viscosity. This pre-mix was combined with the microencapsulated peroxide curing agent described above, along with various additional additives and fillers. Thereafter, the composition was added to an unsaturated polyester resin to form the molding resin for the Conductive SMC.

Two additional molding resins were prepared for comparative purposes, using essentially the same amount of unsaturated polyester resin but variations in the curing agent and the electrically conductive filler. The first comparative molding resin for SMC (hereinafter, “Comparative SMC”) utilized a conventional non-microencapsulated peroxide curing agent together with electrically conductive carbon. The second comparative molding resin for SMC (hereinafter, “General SMC”) utilized a microencapsulated peroxide curing agent, but did not include any electrically conductive carbon.

The compositions of the three molding resins is set forth in Table 1. As shown in Table 1, the ratio of conductive filler to thermosetting resin was 14.1% in both the Comparative SMC and the Conductive SMC.

TABLE 1
Molding Resin Formulation

| | | | Comparative | General | Conductive |
|---|---|---|---|---|---|
| | | unit | SMC | SMC | SMC |
| Ratio in Resin | Unsaturated polyester resin | wt. % | 46.3 | 49.5 | 45.8 |
| Compound | Polystyrene | wt. % | 6.0 | 6.4 | 5.9 |
| (Paste) | Curing agent (Non- | wt. % | 0.6 | — | — |
| | microencapsulated peroxide) | | | | |
| | Curing agent (Micro- | wt. % | — | 1.9 | 1.7 |
| | encapsulated peroxide) | | | | |
| | Mold release agent | wt. % | 3.0 | 3.2 | 3.0 |
| | (Stealic acid) | | | | |
| | Filler (Calcium carbonate) | wt. % | 36.0 | 38.5 | 35.6 |
| | Electrically conductive | wt. % | 7.6 | — | 7.5 |
| | carbon filler | | | | |
| | Thickening agent | wt. % | 0.5 | 0.5 | 0.5 |
| | (Magnesium oxide) | | | | |
| | Total as resin compound | | 100 | 100 | 100 |

Thereafter, each of the three molding resins was formulated into a sheet molding compound by combining each molding resin with chopped glass fibers having an average length of about 25.4 mm, the chopped glass fibers being made from a glass fiber strand having a yarn count of 75 gms/km, a bundling number of 150 filaments per strand, and an average filament diameter of about 15.6 μm. The glass fiber strand was sized with 0.95 wt. % of a sizing agent containing a silane coupling agent, a polyurethane resin, and a polyvinyl acetate resin. Each of the sheet molding compounds so made was then molded into a flat plate having thickness of 2 mm by means of a hot-press molding machine in which an upper plate heated to 140° C. and a lower plate heated to 145° C. were compressed together at a pressure of 8.3 MPa. After 4 minutes under these conditions, the plates were opened and the molded plate visually inspected for surface appearance and condition of cure.

Tables 2 and 3 show the overall compositions of the Conductive SMC and the two comparative sheet molding compounds. As shown below, the ratio of conductive filler to thermosetting resin was 14.1% in the Comparative SMC, and 14.2% in the Conductive SMC.

TABLE 2
SMC Formulation

| | | | Comparative | General | Conductive |
|---|---|---|---|---|---|
| | | unit | SMC | SMC | SMC |
| Ratio in Resin | Unsaturated polyester resin | wt. % | 32.4 | 34.7 | 32.1 |
| Compound | Polystyrene | wt. % | 4.2 | 4.5 | 4.1 |
| (Paste) | Curing agent (Non- | wt. % | 0.4 | — | — |
| | microencapsulated peroxide) | | | | |
| | Curing agent (Micro- | wt. % | — | 1.3 | 1.2 |
| | encapsulated peroxide) | | | | |
| | Mold release agent | wt. % | 2.1 | 2.2 | 2.1 |
| | (Stealic acid) | | | | |
| | Filler (Calcium carbonate) | wt. % | 25.2 | 26.9 | 24.9 |
| | Electrically conductive | wt. % | 5.3 | — | 5.3 |
| | carbon filler | | | | |
| | Thickening agent | wt. % | 0.3 | 0.4 | 0.3 |
| | (Magnesium oxide) | | | | |

| | | | | |
|---|---|---|---|---|
| Ratio of glass fiber | wt. % | 30.0 | 30.0 | 30.0 |
| Total as SMC | wt. % | 100 | 100 | 100 |

TABLE 3
SMC Overall Formulation

| | | | Compar- | | Con- |
|---|---|---|---|---|---|
| | | | ative | General | ductive |
| | | unit | SMC | SMC | SMC |
| Weight | Resin compound | wt. % | 64.7 | 70.0 | 64.7 |
| Ratio | (Except for | | | | |
| In | electrical | | | | |
| SMC | conductive | | | | |
| | carbon filler) | | | | |
| | Electrical | wt. % | 5.3 | 0.0 | 5.3 |
| | conductive | | | | |
| | carbon filler in | | | | |
| | resin compound | | | | |
| | Glass fiber | wt. % | 30 | 30 | 30 |

| | | | | |
|---|---|---|---|---|
| Total as SMC | wt. % | 100 | 100 | 100 |

Table 4 shows the electrical conductivity for the Conductive SMC relative to the two comparative sheet molding compounds. Volume resistivity for each sheet molding compound was tested in accordance with the JIS K 6911 testing methods, under conditions of 23° C. (±2° C.) and 50±5 RH %. The volume resistivity was measured using a High Resistance Meter 43398 from Agilent Technologies.

TABLE 4
Electrical Conductivity

| | | Comparative | General | Conductive |
|---|---|---|---|---|
| | unit | SMC | SMC | SMC |
| Volume resistivity | Ωcm | 6.33 × 10⁷ | 8.80 × 10¹⁵ | 8.73 × 10⁵ |
| Electrical property | | Conductive | Insulating | Conductive |
| | | plastics | | plastics |
| | | (antistatic | | (antistatic |
| | | level) | | level) |

The shelf-life of the Conductive SMC relative to the two comparative sheet molding compounds is shown in Table 5. Each SMC was aged for two days at 40° C., and then for 23 days at 23° C., for a total period of 25 days. The GT (gel time) and CT (cure time) values were measured using a Cure Tool. The Cure Tool included a thermocouple installed in the molding die to measure exothermal temperature during SMC curing.

TABLE 5
Shelf Life of SMC

| | | Comparative | General | Conductive |
|---|---|---|---|---|
| | unit | SMC | SMC | SMC |
| Curing agent | | Peroxide | Microencapsulated peroxide | |
| Electrical conductive | wt. % | 5.3 | 0 | 5.3 |
| carbon filler | | | | |
| After 2 days | | | | |
| GT (a) | sec. | 47.2 | 15.0 | 8.8 |
| CT (b) | sec. | 75.0 | 31.0 | 21.0 |
| After 25 days | | | | |
| GT (c) | sec. | 35.0 | 14.0 | 10.4 |
| CT (d) | sec. | 50.0 | 30.0 | 26.2 |
| [symbol] GT = c-a | sec. | −12.2 | −1.0 | 1.6 |
| [symbol] CT = b-d | sec. | −25.0 | −1.0 | 5.2 |

Table 6 shows the shelf life of the resin compound/paste of the Conductive SMC relative to the two comparative sheet molding compounds:

TABLE 6
Shelf Life of SMC Resin Compound/Paste

| | | Comparative | General | Conductive |
|---|---|---|---|---|
| | unit | SMC | SMC | SMC |
| Curing agent | | Peroxide | Microencapsulated | |
| | | | peroxide | |
| Electrical conductive | wt. % | 5.3 | 0 | 5.3 |
| carbon filler | | | | |
| After 15 days at | | x | ∘ | ∘ |
| room temp | | (Cured) | (Not cured) | (Not cured) |
| After 25 days at | | — | ∘ | ∘ |
| room temp | | | (Not cured) | (Not cured) |

Tables 5 and 6 above show that the [symbol] GT and [symbol] CT of the Comparative SMC were greater than the [symbol] GT and [symbol] CT of the Conductive and General SMCs. This effect is due to the reaction and decomposition of the non-microencapsulated peroxide during the storage term. In contrast, the Conductive SMC including a microencapsulated peroxide exhibits a sufficient shelf life.

From the foregoing, it can be seen that the general inventive concepts include at least the following points of invention:

A. An electrically conductive fiber reinforced thermosetting resin molding compound comprising a thermosetting resin, an electrically conductive filler, and a microencapsulated curing agent.

B. The electrically conductive fiber reinforced thermosetting resin molding compound of A, wherein the electrically conductive filler and the thermosetting resin are a premix.

C. The electrically conductive fiber reinforced thermosetting resin molding compound of A or B, wherein the electrically conductive filler comprises from about 5 wt. % to about 40 wt. % by weight of the thermosetting resin.

D. The electrically conductive fiber reinforced thermosetting resin molding compound of any of A-C, wherein the electrically conductive filler comprises from about 10 wt. % to about 30 wt. % by weight of the thermosetting resin.

E. The electrically conductive fiber reinforced thermosetting resin molding compound of any of A-D, wherein the microencapsulated curing agent comprises an organic peroxide curing agent and a polyurethane resin encapsulating the organic peroxide curing agent.

F. The electrically conductive fiber reinforced thermosetting resin molding compound of any of A-E, wherein the electrically conductive filler is selected from aluminum, steel, copper, zinc, silver, palladium, nickel, stainless steel, zinc oxide, tin oxide, carbon, carbon black, metal coated glass fiber, and metal coated glass balloon.

G. The electrically conductive fiber reinforced thermosetting resin molding compound of any of A-E, wherein the electrically conductive filler comprises electrically conductive carbon

H. The electrically conductive fiber reinforced thermosetting resin molding compound of any of A-G, wherein the microencapsulated curing agent contains about 30 wt % or more organic peroxide curing agent.

I. The electrically conductive fiber reinforced thermosetting resin molding compound of any of A-H, wherein the polyurethane resin is formed from a polyol, an optional amine, and an isocyanate selected from the group consisting of xylylene diisocyanate, hydrogenated xylylene diisocyanate, hexamethylene diisocyanate, isophorone diisocyanate and polyisocyanates obtained from these diisocyanates.

J. A process for making an electrically conductive fiber reinforced composite comprising:
providing the electrically conductive fiber reinforced thermosetting resin molding compound of any of A-I;
forming at least one of glass fibers and carbon fibers into a desired shape;
mixing the fibers and the fiber reinforced thermosetting resin molding compound; and
heating the shaped mixture so formed, wherein the heating step causes the curing agent of the electrically conductive fiber reinforced thermosetting resin molding compound to decompose and thereby cure to form the electrically conductive fiber reinforced composite.

Although only a few exemplary embodiments are presented in this disclosure, it should be appreciated that many modifications can be made without departing from the spirit and scope of the general inventive concepts. All such modifications are intended to be included within the scope of the general inventive concepts, which are to be limited only by the following claims.

1. An electrically conductive fiber reinforced thermosetting resin molding compound comprising a thermosetting resin, an electrically conductive filler, and a microencapsulated curing agent.

2. The electrically conductive fiber reinforced thermosetting resin molding compound of claim 1, wherein the electrically conductive filler and the thermosetting resin are a premix.

3. The electrically conductive fiber reinforced thermosetting resin molding compound of claim 2, wherein the electrically conductive filler comprises from about 5 wt. % to about 40 wt. % by weight of the thermosetting resin.

4. The electrically conductive fiber reinforced thermosetting resin molding compound of claim 3, wherein the electrically conductive filler comprises from about 10 wt. % to about 30 wt. % by weight of the thermosetting resin.

5. The electrically conductive fiber reinforced thermosetting resin molding compound of claim 1, wherein the microencapsulated curing agent comprises an organic peroxide curing agent and a polyurethane resin encapsulating the organic peroxide curing agent.

6. The electrically conductive fiber reinforced thermosetting resin molding compound of claim 1, wherein the electrically conductive filler is selected from aluminum, steel, copper, zinc, silver, palladium, nickel, stainless steel, zinc oxide, tin oxide, carbon, carbon black, metal coated glass fiber, and metal coated glass balloon.

7. The electrically conductive fiber reinforced thermosetting resin molding compound of claim 1, wherein the electrically conductive filler comprises electrically conductive carbon.

8. The electrically conductive fiber reinforced thermosetting resin molding compound of claim 5, wherein the microencapsulated curing agent contains about 30 wt % or more organic peroxide curing agent.

9. The electrically conductive fiber reinforced thermosetting resin molding compound of claim 5, wherein the polyurethane resin is formed from a polyol, an optional amine, and an isocyanate selected from the group consisting of xylylene diisocyanate, hydrogenated xylylene diisocyanate, hexamethylene diisocyanate, isophorone diisocyanate and polyisocyanates obtained from these diisocyanates.

10. A process for making an electrically conductive fiber reinforced composite comprising:
providing the electrically conductive fiber reinforced thermosetting resin molding compound of claim 1;
forming at least one of glass fibers and carbon fibers into a desired shape;
mixing the fibers and the fiber reinforced thermosetting resin molding compound; and
heating the shaped mixture so formed, wherein the heating step causes the curing agent of the electrically conductive fiber reinforced theiniosetting resin molding compound to decompose and thereby cure to form the electrically conductive fiber reinforced composite.
